(19) United States
(12) Patent Application Publication
(10) Pub. No.: US 2010/0128351 A1
(43) Pub. Date: May 27, 2010

(54) CURVED SIDED CONE STRUCTURES FOR CONTROLLING GAIN AND VIEWING ANGLE IN AN OPTICAL FILM

(75) Inventors: Kenneth A. Epstein, Saint Paul, MN (US); Timothy J. Hebrink, Scandia, MN (US); Charles D. Hoyle, Stillwater, MN (US); Dale L. Ehnes, Cotati, CA (US); Michael P. Keyes, Minneapolis, MN (US); Thomas R. Corrigan, Saint Paul, MN (US); Randy S. Bay, Woodbury, MN (US); Thomas R. Hoffend, JR., Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/275,631

(22) Filed: Nov. 21, 2008

(51) Int. Cl. G02B 5/00; B29D 11/00

(52) U.S. Cl. 359/613; 264/2.7

(57) ABSTRACT

A method of making an optical film includes the steps of making a substrate having a first major surface and a second major surface opposite the first surface and forming a plurality of curved sided cone structures on the first surface. Each of the curved sided cone structures include a base located on the first surface, a vertex, and a curved side formed from an arc extending between the base and the vertex. The optical gain and viewing angle for the film can be controlled by adjusting angles representing a shape of each curved sided cone structure at its vertex and base.

### BACKGROUND

Structured surfaces divert light, inducing an up and down asymmetry in the transmission and reflection characteristics. Films having structured surfaces reflect light of one incidence distribution and transmit light of another distribution. Light incident on a structured surface lying in a plane can tend toward forward transmission in such a way that there is optical gain in a recycling backlight. A strong reflection of near-normal incidence light also serves to conceal defects that may exist in layers lying beneath or within the film. Both brightness gain and defect hiding are desired in the backlights of liquid crystal display (LCD) devices.

Other gain enhancement films include films having linear prisms such as brightness enhancement film and gain diffusers. Linear prism films can have high gain (>1.5) and asymmetric transmission profiles, whereas gain diffusers tend to be rotationally symmetric in their optical properties and tend to have lower gain (1.2-1.4).

Related art examples also serve to hide defects. PCT Application Publication No. WO2006/073806A1 (Whitney et. Al) discloses a film that exhibits perfect spherical protrusions populated on a film surface, which simulates the ideal gain diffuser. PCT Applications Publication Nos. WO2006/121690A1 (Whitney et. al) and WO2007016076A1 (Whitney et. al) disclose curved surface pyramidal protrusions with rounded peaks. U.S. Pat. No. 6,752,505 describes varieties of protrusions including cones and pyramids.

### SUMMARY

A method of making an optical film, consistent with the present invention, includes the steps of making a substrate having a first major surface and a second major surface opposite the first surface and forming a plurality of curved sided cone structures on the first surface. Each of the curved sided cone structures include a base located on the first surface, a vertex, and a curved side formed from an arc extending between the base and the vertex. Alternately, the curved surface cones could be concave in to the first surface, and possibly separate curved surface cones could be formed on both major surfaces, convex on the first major surface and concave on the second major surface or convex cones or concave cones on both surfaces. The curved surface cones on the first major surface can have different design parameters than the curved surface cones on the second major surface to provide more control of the light through the film.

An article, consistent with the present invention, includes an optical film having curved sided cone structures. In the article, the optical gain and viewing angle for the film are controlled by adjusting angles representing a shape of each curved sided cone structure at its vertex and base. The gain and viewing angle can also be affected by the relative locations of the curved sided cone structures with respect to each other, considering whether they are at randomized locations or fixed matrix locations.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram illustrating the formation of a curved sided cone structure;

FIG. 2 is a side view illustrating a curved sided cone structure;

FIG. 3 is a perspective view illustrating a plurality of curved sided cone structures in an optical film;

FIG. 4 is a diagram illustrating optical gain in a recycling cavity;

FIG. 5 is a perspective view illustrating a pyramidal curved sided cone structure;

FIG. 6 is a graph of gain and viewing angle for a film having curved sided cone structures; and

FIG. 7 is a graph of gain and viewing angle for two crossed films each having curved sided cone structures.

### DETAILED DESCRIPTION

Embodiments of the present invention include an optical film surface-patterned with a two-dimensional array of generally cone-shaped surface relief structures, which may be rotationally symmetric and preferably have a discontinuous derivative at their vertices. Other embodiments include a manufacturing method for the film. An alternative embodiment includes a curved facet pyramid with a discontinuous derivative along one or two symmetry ridges and a manufacturing method for the same. The advantages of the particular curved shapes with discontinuous surface derivatives include higher optical gain, less punch through or direct transmission of incident light, and consequently improved defect hiding. Embodiments of the present invention are shown to provide better defect hiding than the related art examples and higher gain than the spherically shaped beaded gain structures.

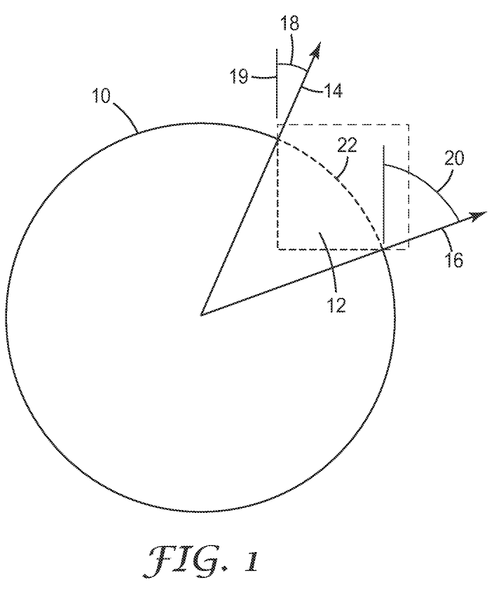

The surface structure is a two-dimensional surface relief array of cone shapes or curve sided cone (CSC) structures that may be closely packed on a surface or arranged to fill the surface such that no flat areas remain. The basic replicated shape is rotationally symmetric; hence the cross-sectional shape is sufficient to define an example. A cross-section 12 of the CSC structure is illustrated in FIG. 1, where a curved edge of circle 10 is terminated at two ends of an arc created by radii 14 and 16. The radius of the circle 10 and the terminal angles Θ₁ (18) and Θ₂ (20) define the cross-section. The angle Θ₁ (18) refers to the angle between radius 14 and the axis of rotation 19. The angle Θ₂ (20) refers to the angle between radius 16 of arc 22 and a vector parallel to the axis of rotation, passing through the intersection of arc 22 and vector 16.

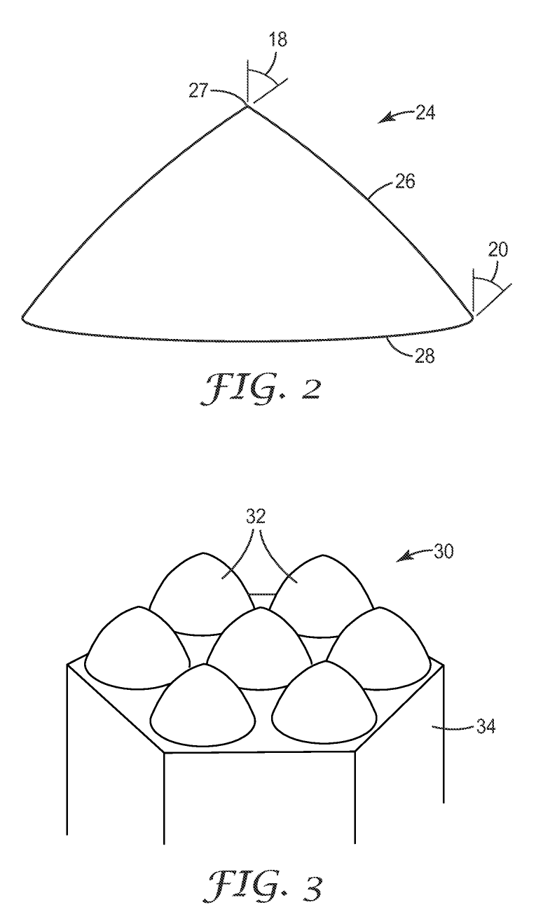

FIGS. 2 and 3 depict, respectively, a CSC structure 24 formed by rotating the selected cross-section, such as section 12, around its axis of rotation 19 and a film 30 populated with the CSC structures 32 on the surface of a film substrate 34. As shown in FIG. 2, CSC structure 24 has a base 28, a vertex 27, and a symmetrical curved side 26 extending between base 28 and vertex 27. The base 28 is in contact with film substrate 34 and preferably formed integral with the substrate. In this example, CSC structure 24 has a convex curved side 26, although other types of curved sides are possible as described below. Also, curved side 26 need not necessarily be formed from a portion of a circle as shown with arc 22; rather, curved side 26 can be formed from other shapes of arcs as determined by angles Θ₁ (18) and Θ₂ (20).

CSC structures may be populated randomly on the surface or on ordered lattice centers. The CSC structures may be uniform in size, or the sizes may be regularly or randomly distributed. The two basic ordered tile lattices are six-fold (hexagonal), as illustrated in FIG. 3, or four-fold (square). On ordered lattices, the rotationally symmetric cone structures may be sized and placed on the tile lattice in the following arrangements: (1) closely packed configuration (circular bases touching); (2) filled lattice, such that the bases of three or four neighboring CSCs overlap. and where the volume overlap of the CSC structures removes volume near the base where the surface slope is steepest; (3) sub-closely packed configuration, where the flat surface area is greater than the close packed limit; and (4) any configuration in the continuum between configurations (1) and (2). Random arrangements of CSC structures may include analogous configurations.

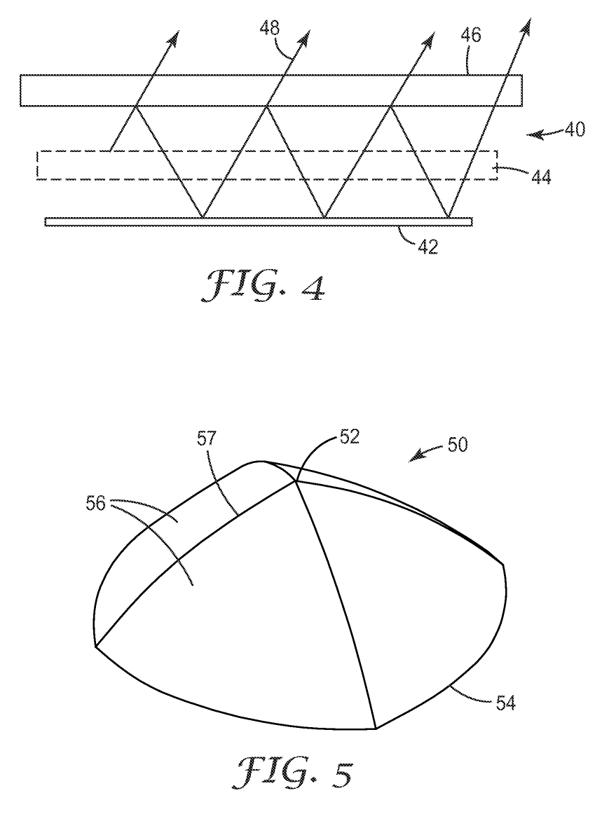

FIG. 4 is a diagram illustrating optical gain in a recycling cavity in an LCD backlight 40. Backlight 40 includes a reflector 42, a light source 44, and an optical film 46 for recycling of light rays 48. Optical film 46 includes CSC structures. Backlight 40 can include additional components or films as well.

Various alternative CSC structures can be used in optical films, aside from the CSC structure shown in FIG. 2. In particular, FIG. 5 depicts a four-sided curved facet pyramid CSC structure 50, which can be populated in a closely packed or filled array on a film substrate. CSC structure 50 has a base 54, vertex 52, and four curved sides 56 joined by ridges 57. In this case, the curved sides were created by sweeping a cross section, such as section 12, along an axis perpendicular to axis 19.

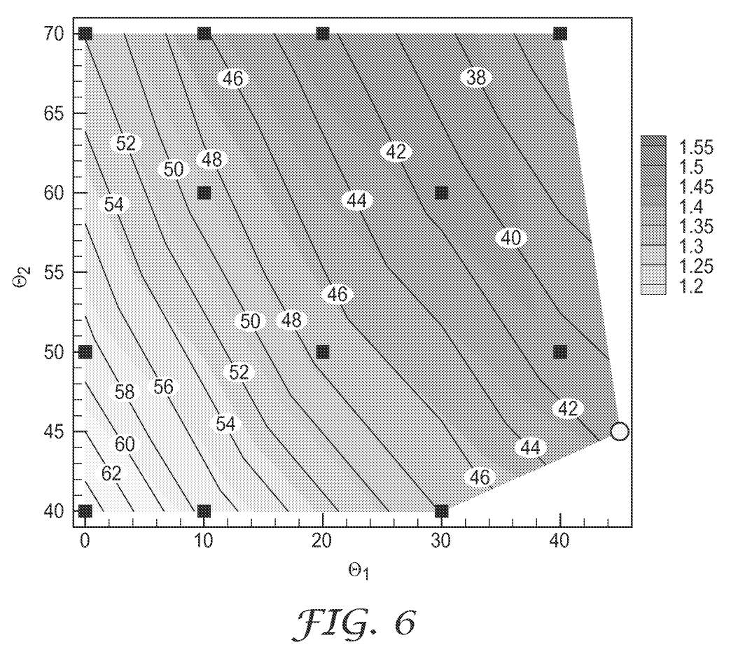

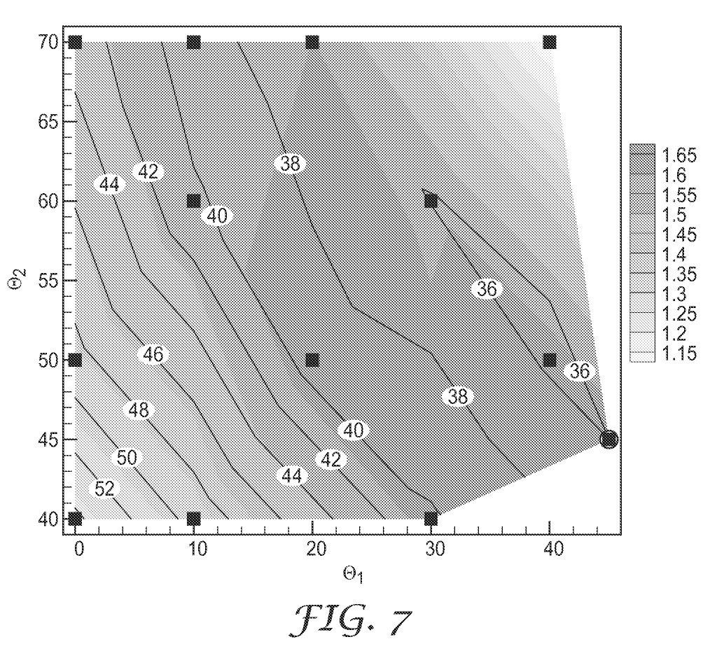

The shape of the CSC can be adjusted by changing Θ₁ (18) and Θ₂ (20). FIG. 6, further described below, shows the relationship between the gain, shown by the gray scale values between 1.2 and 1.55, and viewing angle, shown by the constant value lines representing viewing angles between 38 and 62 degrees. The values represent a range of Θ₁ and Θ₂ values for a film with a refractive index around 1.59. FIG. 7 shows similar gain and viewing angles from light passing through two identical sheets of CSC on top of each other, with a refractive index around 1.59. The term “viewing angle” represents either the horizontal or vertical viewing angle of a display incorporating the film.

### Manufacturing Process

CSC structures on an optical film can be made from a copper replication tool patterned with a diamond turning machine (DTM). Examples of a DTM using a fast tool servo (FTS) are described in the following patents, all of which are incorporated herein by reference as if fully set forth: U.S. Pat. Nos. 7,350,442; 7,350,441; 7,293,487; and 7,290,471. The diamond, lapped to a twin radius tip, can be plunged and withdrawn from the copper tool with a piezo-electric stage as the tool rotates. In some embodiments the FTS device will move the diamond cutting tool along a waveform that matches the profiled twin-radius shape of the diamond. Other embodiments may be desired where the FTS profile is different from the diamond profile; asymmetric CSCs may be produced by this method. Randomization of the surface pattern eliminates color moire and can further hide defects.

Machining techniques can be used to create a wide variety of work pieces such as microreplication tools used in a microreplication process. Microreplication tools are commonly used in a microreplication process such as extrusion processes, injection molding processes, embossing processes, casting processes, or the like, to create microreplicated structures. The microreplicated structures may comprise optical films, abrasive films, adhesive films, mechanical fasteners having self-mating profiles, or any molded or extruded parts having microreplicated features of relatively small dimensions, such as dimensions less than approximately 1000 microns. The CSC structures, such as those described above, typically have a diameter (or width) and pitch within the range of 10 microns to 100 microns, preferably 10 microns to 50 microns, and more preferably 10 microns to 30 microns. The pitch of the CSD structures is approximately equal to their diameter if the bases of adjacent CSC structures are in contact. However, the pitch may be less than or greater than the diameter if adjacent CSC structures are overlapping or if a space exists between adjacent CSC structures.

The microstructures can also be made by various other microreplication processes. For example, the structure of the master tool can be transferred on other media, such as to a belt or web of polymeric material, by a cast and cure process from the master tool to form a production tool; this production tool is then used to make the prismatic structure. Other methods such as electroforming can be used to copy the master tool. Another alternate method to make a light directing film is to directly cut or machine a transparent material to form the prismatic structures.

Other techniques include chemical etching, bead blasting, or other stochastic surface modification techniques. However, those techniques are typically not capable of forming the sharp, precise microstructures and the breadth of features desired to obtain the appropriate light diffusion characteristic achieved with a cutting tool using the methods of the present invention. In particular, these methods are typically not capable of producing highly accurate, repeating structures because of the inherent impreciseness and un-repeatability associated with chemical etching, bead blasting, and other stochastic surface modification techniques. Metal micro-replication tooling can be made with surface structures negative to those shown in FIG. 5 by diamond turned machining as described in U.S. Patent Application Publication Nos. 2007/0107567A1 and 2007/0107568A1, both of which are incorporated herein by reference as if fully set forth.

Another method of making CSC structures on an optical film includes using a polymer or metal master tool made using laser ablation. An excimer or other laser can be used via several known techniques to modify a polymer or metal surface to create a controlled structure. A mask can be used with an assortment of holes in it corresponding nominally to the cross-sectional diameters of the desired CSC. When the regions corresponding to those holes are ablated with the laser and superimposed on top of each other, as described in U.S. Pat. No. 6,285,001, which is incorporated herein by reference as if fully set forth, then a tool populated with CSC structures can be created. If the tooling is a flat polymer, then it may be copied by electroforming into a metal such as nickel. A flat metal tool can be rolled and welded into a cylindrical shape. A cylindrical tool with a polymer surface can also be directly machined eliminating any seam as described in U.S. patent application Ser. No. 11/941,206, filed Nov. 16, 2007, and entitled “Seamless Laser Ablated Roll Tooling,” which is incorporated herein by reference as if fully set forth.

### Optimized Film for Gain and Viewing Angle

Based upon optical modeling, the optical gain and viewing angle can be controlled for a film having CSC structures by adjusting angles Θ₁ (18) and Θ₂ (20). Optical modeling can be performed using optical ray tracing software, and ray tracing techniques are known in the art. FIG. 6 is a graph of gain and viewing angle based upon angles Θ₁ (18) and Θ₂ (20) for a film having CSC structures protruding from the surface. FIG. 7 is a graph of gain and viewing angle based upon angles Θ₁ (18) and Θ₂ (20) for two films crossed at 90° and each having CSC structures protruding from the surface. In the graphs of FIGS. 6 and 7, the viewing angles are shown in the ovals along the contour lines, and the on-axis optical gain is shown by the shading and the legend on the side of the graphs. For the modeling results shown in FIGS. 6 and 7, the film material was 7 mil thick polyethylene terephthalate (PET) with the CSC structures having a refractive index of 1.5895, and the CSC structures were replicated on a hexagonal lattice substrate, as illustrated in FIG. 3.

Angles Θ₁ (18) and Θ₂ (20) are shown in degrees on the x-axis and y-axis, respectively, of the charts, and those angles are defined above and illustrated in FIGS. 1 and 2, and they relate to a shape of the side of the CSC structure at the vertex and base. Although the modeling was performed for structures protruding from the substrate surface, CSC structures can also include structures indenting into the substrate surface.

The term “viewing angle” as used in FIGS. 6 and 7 means the angle at which the conoscopic plot of gain versus polar angle equals 50% of the value as measured on axis. It is essentially the angle of viewing a display where it appears half as bright compared to viewing the display on an axis perpendicular to it. Other parameters for viewing angles are possible depending upon, for example, a desired brightness of a display incorporating the film with CSC structures when viewed at particular angles off axis.

### EXAMPLES

The following examples describe implementations of the present invention. Additional material combinations can also be used to create these films or sheets, and examples of such materials are described in U.S. patent application Ser. No. 11/735,684, filed Apr. 16, 2007, which is incorporated herein by reference as if fully set forth.

In the Examples, the following are the chemical descriptions for the acronyms in the UV cured acrylate formula: TMPTA=triemethyl propane triacrylate; PEA=phenoxy ethyl acrylate; BEDA=brominiated diacrylate; and TPO=thermoplastic polyolefin.

### Example 1

UV curable acrylate coating solution (10 wt % TMPTA, 25 wt % PEA, 65 wt % BEDA, 1.0 wt % TPO) having a refractive index of 1.56 was coated onto 5 mil thick PET film and embossed with an excimer laser ablation polyimide tool made as described above to create a curve sided cone structures film surface similar to the structure shown in FIG. 1. The film was passed under an ultraviolet (UV) lamp (300 Watt/centimeter (cm)) at 15 feet per minute (fpm) to cure the acrylate monomers into a solid polymer. This film had a haze of 99% measured with a Gardner haze meter and provided a luminance gain of 1.47 using an Effective Transmission Tester. The curve sided cone structures and roughness on the surface of this film were observed to provide exceptional spot defect hiding.

### Example 2

UV curable acrylate coating solution (10 wt % TMPTA, 25 wt % PEA, 65 wt % BEDA, 1.0 wt % TPO) having a refractive index of 1.56 was coated onto 5 mil thick PET film and embossed with an excimer laser ablation polyimide tool made as described above to create a curve sided cone structures film surface similar to the structure shown in FIG. 1. The film was passed under a UV lamp (300 Watt/cm) at 15 fpm to cure the acrylate monomers into a solid polymer. This film had a haze of 99% measured with a Gardner haze meter and provided a luminance gain of 1.42 using an Effective Transmission tester. The curve sided cone structures and roughness on the surface of this film were observed to provide exceptional spot defect hiding.

1. A method of making an optical film, comprising the steps of:
making a substrate having a first major surface and a second major surface opposite the first surface; and
forming a plurality of curved sided cone structures on the first surface, each of the curved sided cone structures comprising a base located on the first surface, a vertex, and a curved side formed from an arc extending between the base and the vertex,
wherein the making and forming steps are performed using a microreplication process.

2. The method of claim 1, wherein the forming step includes forming the base of each of the curved sided cone structures in contact with the base of another one of the curved sided cone structures.

3. The method of claim 1, wherein the forming step includes forming the base of each of the curved sided cone structures separated by a space from the base of another one of the curved sided cone structures.

4. The method of claim 1, wherein the forming step includes forming the curved side of the curved sided cone structures as convex.

5. The method of claim 1, wherein the forming step includes forming the curved side of the curved sided cone structures as concave.

6. The method of claim 1, wherein the forming step includes forming the curved side of each of the curved sided cone structures as a plurality of discrete curved sides joined by ridges.

7. The method of claim 1, wherein the forming step includes forming the curved side of each of the curved sided cone structures as a plurality of curved segments joined by ridges.

8. The method of claim 1, wherein the forming step includes forming the curved side of each of the curved sided cone structures as a plurality of curved segments joined by flat portions.

9. The method of claim 1, wherein the forming step includes forming the curved side of each of the curved sided cone structures as symmetrical.

10. The method of claim 1, wherein the forming step includes forming the curved sided cone structures integral with the substrate.

11. An optical film, comprising:
a substrate having a first major surface and a second major surface opposite the first surface; and
a plurality of curved sided cone structures on the first surface, each of the curved sided cone structures comprising a base located on the first surface, a vertex, and a curved side formed from an arc extending between the base and the vertex,
wherein an optical gain and a viewing angle of the film are controlled by adjusting a first angle between a radius of the arc and a first axis perpendicular to the base and extending through the vertex and adjusting a second angle between the radius of the arc and a second axis perpendicular to the base and extending through the base.

12. The film of claim 11, wherein the first and second angles are adjusted to provide for a maximum optical gain of the film.

13. The film of claim 11, wherein the first and second angles are adjusted to provide for a maximum viewing angle of the film.

14. The film of claim 11, wherein the curved sided cone structures are arranged in a hexagonal lattice pattern on the substrate.
